(19) United States
(12) Patent Application Publication
(10) Pub. No.: US 2017/0211544 A1
(43) Pub. Date: Jul. 27, 2017

(54) Flexible Wind Turbine Apparatus

(71) Applicant: Reinaldo Ivan Olivera, Deerfield, IL (US)

(72) Inventor: Reinaldo Ivan Olivera, Deerfield, IL (US)

(21) Appl. No.: 15/261,873

(22) Filed: Sep. 10, 2016

Related U.S. Application Data
(63) Continuation of application No. 62/281,855, filed on Jan. 22, 2016.

(51) Int. Cl. F03D 3/06; F03D 3/02; F03D 3/00

(52) U.S. Cl. CPC F03D 3/068; F03D 3/005; F03D 3/02; F05B 2240/211; F05B 2250/70; F05B 2250/232; F05B 2250/12; F05B 2250/121; F05B 2250/11

(57) ABSTRACT

An airfoil for a wind turbine apparatus includes an airfoil body having an arcuate shape extending between a first end and a second end and an airfoil support secured to a midpoint on the airfoil body and connected to the outer end of the support arm. The airfoil body includes a first portion adjacent to the first end and a second portion adjacent to the second end. The first end and the second end are secured to the support arm, and the body of the airfoil is comprised of material capable of flexing in response to wind pressure. The first and second portions of the airfoil body extend away from each other in an extended position and collapse together in a collapsed position, and the orientation of the airfoil relative to the direction of the wind causes the airfoil to move between the open and closed positions.

### CROSS-REFERENCE TO RELATED APPLICATIONS

This application incorporates by reference and claims the benefit of priority to U.S. Provisional Patent Application No. 62/281,855 filed Jan. 22, 2016.

### BACKGROUND OF THE INVENTION

The present subject matter relates generally to a wind turbine. More specifically, the present invention relates to a flexible, scalable wind turbine apparatus.

Wind is an important source of renewable energy. According to the US Department of Energy, the amount of wind energy captured in the United States has tripled since the year 2000. Based off projections from the US Department of Energy, this trend of expanded wind energy capture will continue, reaching six times the current levels in the US by 2050. While this expanded use of wind energy, known for being a clean and renewable, has obvious benefits over traditional fossil fuels, the capture of wind does not come without challenges.

One of the biggest obstacles to a wide acceptance of the use of wind energy as a power source is the competition with conventional energy sources in terms of cost. Depending on how resourceful a wind energy producing site is, a given wind farm may or may not be cost competitive with other energy sources due to the higher initial investments needed for wind capturing technology as compared to fossil-fueled generators. Additionally, given the higher level of initial investment needed to set up a wind farm, owners of sites good for wind energy capture may choose to use their land for more profitable activities.

Another monetary obstacle faced by wind energy expansion is that sites good for wind energy production are located remotely from sites that need the electricity. Transmission lines must be built to bring the electricity from wind farms to a city. This use of remote locations for wind farms not only stems from the fact that there may be more wind to capture in rural expanses but is also due to the intrusiveness of traditional wind turbines which may cause noise and aesthetic pollution. A common industrial wind turbine consists of 116 foot blades atop a 212 foot tower for a total height of 328 feet. When in use, such a turbine may be placed no closer than approximately 1000 feet from any home (as dictated by safety rules) and at this distance the turbine still emits a constant sound at a level of over 40 decibels. This noise, combined with the space requirements and what some may feel are aesthetically displeasing features make wind turbines impractical to use near or within cities or towns.

Accordingly, there is a need for a scalable wind turbine capable of optimizing the amount of energy captured to make wind energy both cost competitive and feasible to use in urban environments.

### BRIEF SUMMARY OF THE INVENTION

To meet the needs described above and others, the present disclosure provides a wind turbine including flexible airfoils capable of optimizing the amount of energy captured.

In one embodiment, the scalable wind turbine may include one or more support arms mounted around a rotating center shaft. The arms may extend perpendicular to the center shaft and include flexible airfoils secured thereto. Each support arm may include a single airfoil or a plurality of airfoils spaced along the length of the arm. Each flexible airfoil may be square in shape and extend to a single side of the support arm. The number of arms mounted around the center shaft may vary depending on energy output and space needed for a given turbine. If only one of two opposing supporting arms is to include one or more airfoils, a counterweight may be placed on the support arm opposite the support arm with the airfoils.

In another embodiment, the flexible airfoils of the wind turbine may have a predefined curvature along the length of the airfoil. One purpose of this curvature of the foil is to minimize drag which boosts wind capturing. The airfoils may be square, rectangular, or any other shape which lends itself to capturing wind energy. One airfoil shape which may be used roughly resembles the shape of a whale's tail; that shape being an obtuse triangle which is indented towards the middle of the triangle's hypotenuse with the mounting point of the airfoil located opposite this indention. In this embodiment, the curved airfoils may be mounted perpendicular to the support arms at the end of arms opposite the center shaft. This embodiment may also allow for scalability by use of a counterweight placed on a support arm opposite an airfoil supporting arm if the use of only one airfoil supporting arm is needed.

In yet another embodiment, the flexible airfoils of the wind turbine may span adjacent support arms. The body of the airfoil tapers from a first height at the first support arm to a second height at the second support arm. The tapered airfoil may be connected to support arms positioned ninety degrees or one hundred and eighty degrees from each other. The length of the body between the adjacent support arms includes slack so that the airfoil bends inwardly or outwardly depending on its orientation relative to the direction of the wind. This inward flexing helps capture wind energy and this embodiment may be scaled with as few as a single tapered flexible airfoil connected to two support arms.

In still yet another embodiment, each flexible airfoil is mounted to a support arm of the wind turbine by means of an oscillating band, which allows the airfoil to oscillate and improve the momentum of the rotation of the airfoil. In this embodiment, the shape of the airfoil(s) may be any shape which optimizes the capture of wind energy (square, triangle, rectangle, etc.) and include a predefined curve along its length to further aid in wind energy capture. The flexibility of the oscillating band allows the curved airfoil to move against the wind naturally like a kite, resulting in the airfoil being in a better position to catch the wind's energy. In further embodiments, a control band support may extend from the support arm to the airfoil adjacent to a spaced apart from the oscillating band in order to stabilize the airfoil and keep it from becoming positioned out of optimal orbit around the center shaft. As with the other embodiments, the oscillating airfoil apparatus may be scaled, with as little as one airfoil and one support arm being needed to capture wind energy.

Still other embodiments of this innovation exist including an embodiment with expanding (and contracting) airfoils. This expanding airfoil embodiment captures the wind when facing the direction that the wind is blowing, and then allows the airfoils to collapse as they rotate around a central shaft, out of position to capture the wind. The expansion and collapse of the airfoils of this embodiment are enabled by hinged connections to the support arms of the wind turbine apparatus. The hinged connection which connects each airfoil (which in turn may be composed of flexible or rigid materials as appropriate) to at least one support arm may resemble a traditional door hinge and also allow expansion by any other functional means. These other functional means of enabling expansion (and contraction) of an airfoil may include magnets, hydraulics, or springs. Such functionality may also be utilized to slow or cushion expansion and collapse of an expanding airfoil to prevent damage and/or excessive noise from being generated by the expanding airfoil(s) when in use.

The materials with which any of the above airfoils may be constructed are capable of flexing and deforming from their original shape in response to wind pressure and/or direction. These materials also allow the flexible airfoils to then return to their original shape or take on a new shape in further response to changing wind pressure and/or direction. Such suitable material include, but are not limited to: metals, rubbers, and plastics or other synthetic compounds.

An object of the invention is to provide a wind turbine that is adaptable to various wind conditions for use in urban environments. Currently, standard commercial wind turbines are large, loud, and disruptive to the land that surrounds them. With America's energy needs and population ever increasing, there is a need for a multitude of scalable and adaptable wind turbine designs.

An advantage of the invention is that it provides a scalable design for a wind turbine which can function with as little as one airfoil. This is advantageous because in urban settings, the use of a single airfoil wind turbine may allow wind energy to be captured in a subtle manner, resulting in little or no disturbance to surrounding land or buildings. While the use of such a turbine may not capture as much as a full sized commercial turbine, the ability to use a large number of smaller wind turbines in urban areas could generate a good deal of electricity. This localized electricity generation would eliminate the need to create power grids to bring wind energy into cities from rural areas and help improve the cost competitiveness of wind energy.

Another advantage of the invention is the scalability of the design from a toy size model to a utility size. This invention lends itself to being scaled to a size which can sit easily on a desktop and still feature fully functional airfoils making it useful as a toy or marketing tool.

Yet another advantage of this invention is that a wide array of different airfoil shapes and arrangements may be used. Building and land owners may prefer to have a range of different shaped airfoils available to match what they feel is the most visually appealing shape with their building or land.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a plan view of a vertical axis wind turbine of the present application including planar airfoils.

FIG. 1B is a plan view of an alternative embodiment of the wind turbine of the FIG. 1A including curved airfoils.

FIG. 2 is an exploded view of an airfoil of the wind turbine of FIG. 1A.

FIG. 3 is a side elevation view of support arms including an airfoil balanced by a counterweight.

FIG. 4 is a side elevation view of a further embodiment of a wind turbine of the present application including a plurality of layers of support arms.

FIGS. 5A and 5B are perspective and plan views, respectively, of a further embodiment of a wind turbine of the present application.

FIG. 6 is a perspective view of another embodiment of a wind turbine of the present application including a plurality of curved triangular airfoils.

FIG. 7 is a perspective view of an alternative embodiment of the wind turbine of FIG. 6.

FIG. 8 is a perspective view of a further embodiment of a wind turbine of the present application including curved rectangular airfoils.

FIG. 9 is a perspective view of another embodiment of a wind turbine including an airfoil spanning adjacent support arms.

FIG. 10A is a perspective view of a further embodiment of a wind turbine including a plurality of airfoils spanning adjacent support arms.

FIG. 10B is a perspective view of the wind turbine of FIG. 10A capturing wind energy.

FIG. 11 is a perspective view of an embodiment of a wind turbine including an airfoil with an oscillating band.

FIG. 12 is a perspective view of a further embodiment of a wind turbine including an airfoil with an oscillating band.

FIGS. 13A and 13B are side elevation views of airfoils with oscillating bands formed integrally with the airfoils.

FIG. 14 is a perspective view of a further embodiment of a wind turbine including an airfoil with an oscillating band and a control band.

FIG. 15 is a perspective view of a wind turbine including a plurality of airfoils with control bands.

FIG. 16 is a perspective view of a wind turbine including expandable airfoils.

FIGS. 17A and 17B are perspective views of the expandable airfoil of the wind turbine of FIG. 16 in the collapsed and expanded positions, respectively.

### DETAILED DESCRIPTION OF THE INVENTION

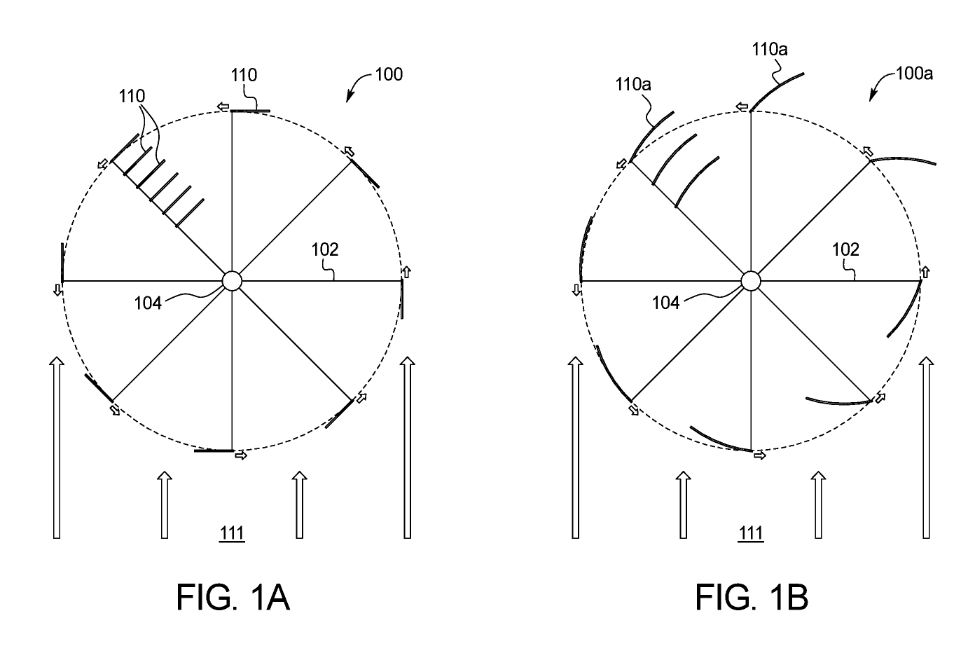

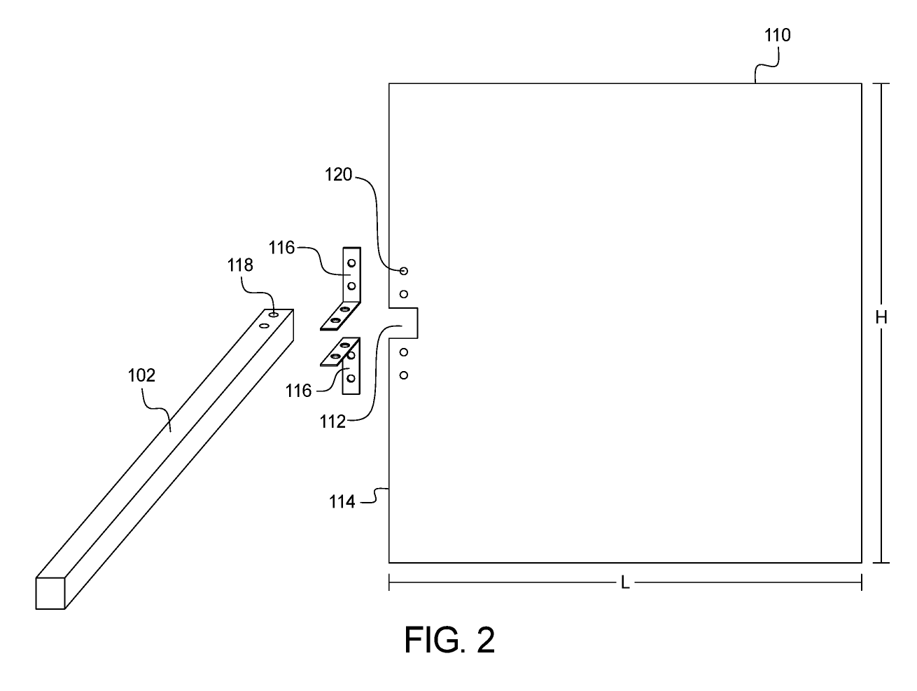

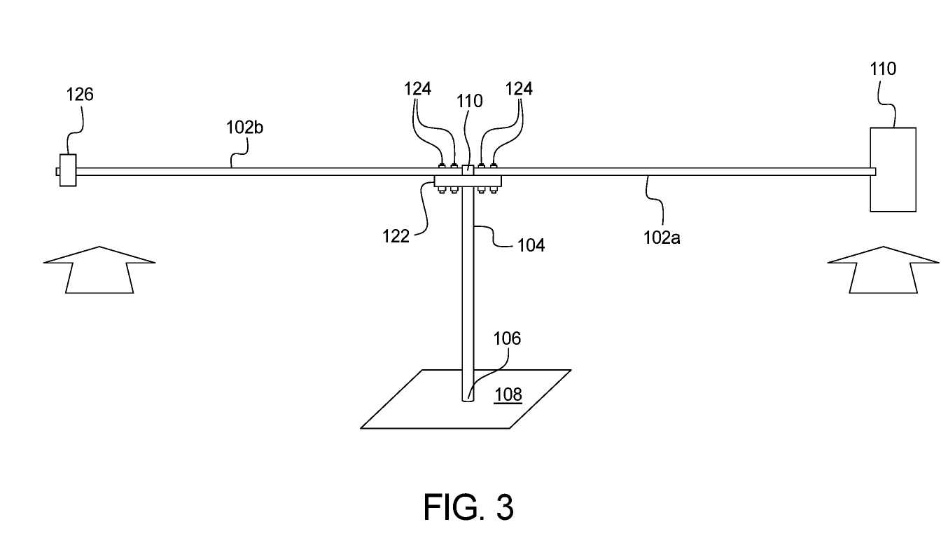

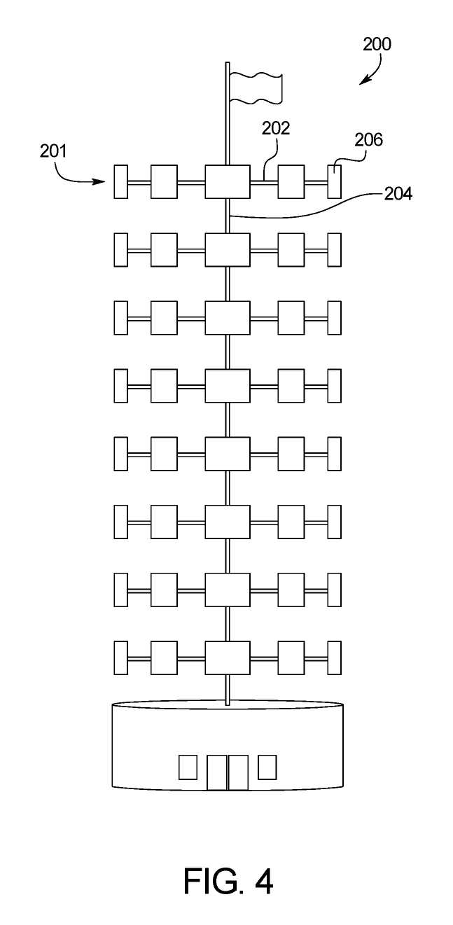

As shown in FIG. 1A, the wind turbine 100 includes one or more support arms 102 that extend from a vertical central rotating shaft 104. A first shaft end 106 is secured to a support base 108 as seen in FIG. 3, and the one or more support arms 102 are connected to the shaft 104 as a second shaft end 110. Each airfoil includes a height H parallel to the shaft and a length L transverse to the height H as shown in FIG. 2. While each of the illustrated embodiments is a vertical axis wind turbine, the airfoil designs described herein may be modified for use on a horizontal axis wind turbine as well.

Referring to FIG. 1A, a wind turbine 100 includes a plurality of support arms 102 extending perpendicular to a central rotating shaft 104 in a circular pattern. Each support arm 102 may include a single or multiple square airfoils 110 mounted to and extending to a single side of the support arm 102. Although the embodiments illustrated in FIGS. 1A-5B include square-shaped airfoils, the airfoil may have any suitable shape or size as desired, such as circular, rectangular, or any polygon. In the wind turbine 100a of FIG. 1B, the airfoils 100a may flex inwards and outwards relative to the central rotating shaft 104a to best capture wind energy 111.

As shown in FIG. 2, the airfoil 110 is mounted to the support arm 102 so that the airfoil 110 extends perpendicular to one side of the support arm 102. While the embodiment illustrated in FIG. 2 shows the airfoil 110 extending to the right of the support arm 102, the airfoil may extend in any direction as necessary or preferred under the design requirements. The support arm 102 extends through a slot 112 along an edge 114 of the square airfoil 110. Fasteners (not shown) extend through mounting brackets 116 and holes 118 in the support arm 102 and holes 120 in the airfoil 110 adjacent to the slot 112 to secure the airfoil 110 to the support arm 102.

As shown in FIGS. 1A and 1B, each support arm 102 of wind turbine 100 may support a plurality of airfoils 110. In the embodiment illustrated in FIG. 3, first and second support arms 102a, 102b are secured to the shaft 104 through a fastening mechanism such as a mounting plate 122 with bolts 124. The first support arm 102a includes an airfoil 110 at an outer end distal from the shaft 104, and the second support arm 102b includes a counterweight 126 at the outer end distal from the shaft 104. In other embodiments, a single support arm may be used in place of the first and second support arms 102a, 102b. The single support arm would attach to the central shaft 104 at a midpoint between the outer ends.

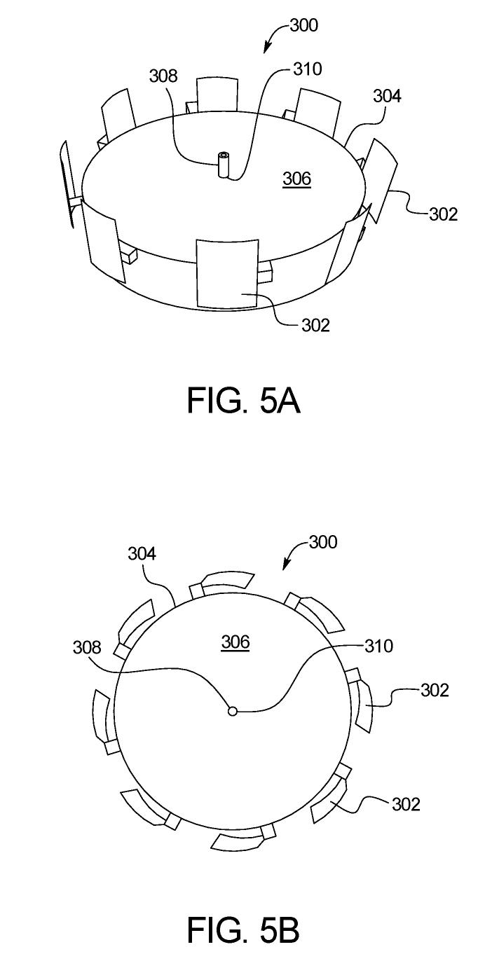

Referring to FIG. 4, an alternative embodiment of the wind turbine 200 includes a plurality of levels 201 of support arms 202. In the illustrated embodiment, each level of support arms 202 is secured to a single central shaft 204. In other embodiments, each level 201 includes a plurality of support arms 202 mounted to a central shaft 204, and the plurality of central shafts 204 are mounted atop one another. This stacked arraignment may aid in maximizing wind collection in a given area.

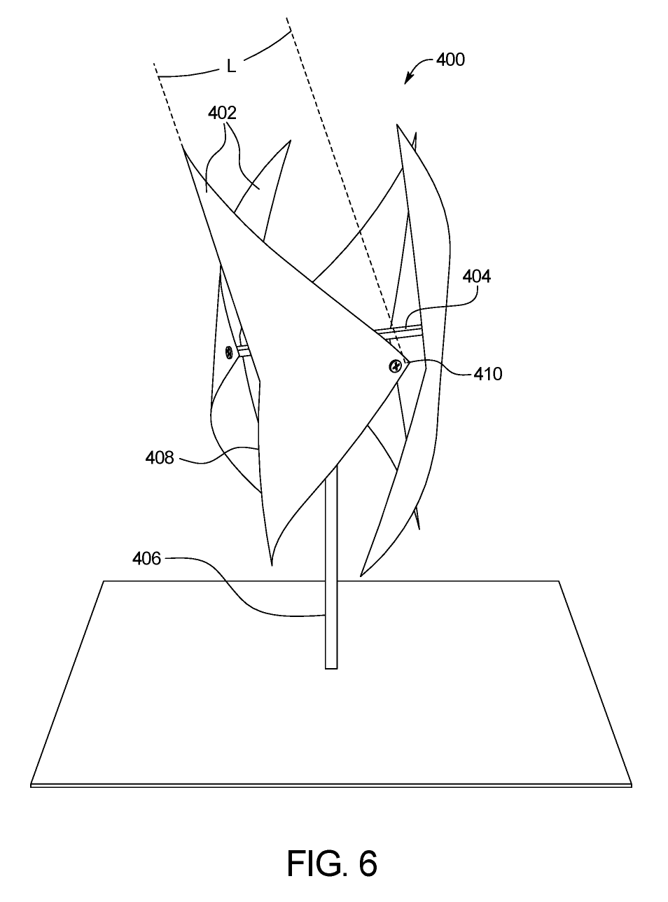

In the further embodiment of the wind turbine 300 illustrated in FIGS. 5A and 5B, the airfoils 302 may be secured to an outer edge 304 of a planar support plate or surface 306 in addition to a support arm 308. In other embodiments, the planar support plate 306 may be used in lieu of the support arms 308. Referring to the embodiment illustrated of FIG. 5A, a plurality of support arms 308 at least partially support the disc support structure 306. Airfoils 302 spaced about the outer edge 304 extending from the plurality of support arms 308. A central shaft 308 may extend through an aperture 310 within the support plate 306 or be secured to an underside of the support plate 306. Still further, the support structure 306 may have a disc shape as illustrated in FIGS. 5A and 5B, or may have any other shape as desired.

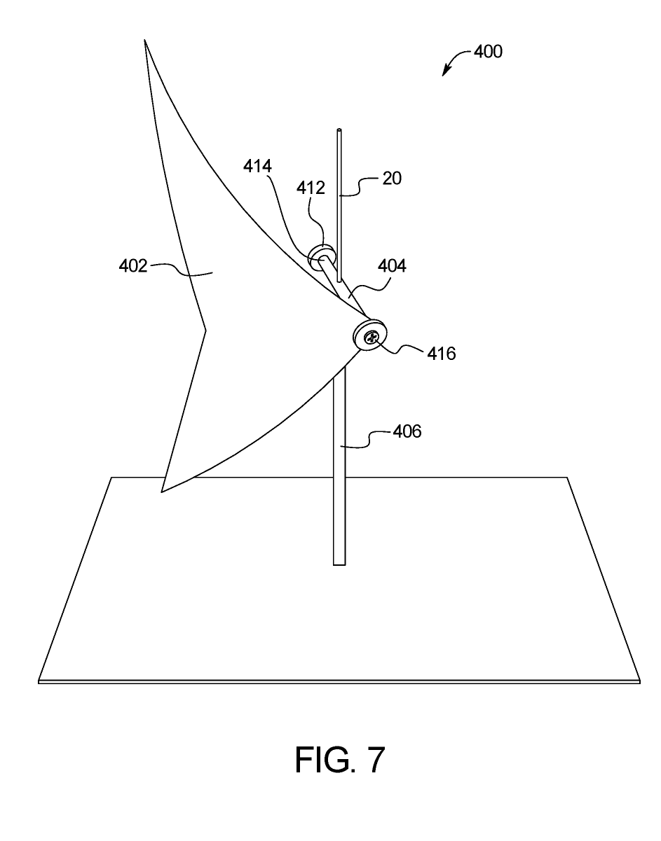

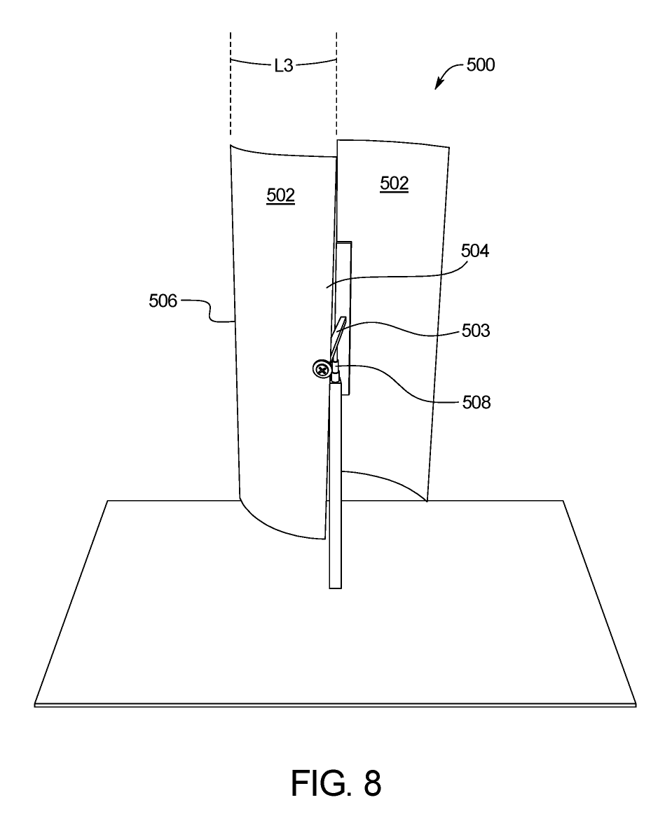

FIG. 6 illustrates a further embodiment of a wind turbine 400 including a plurality of curved triangular airfoil 402, each mounted on a support arm 404 secured to a central shaft 406. The shape of the curved triangular airfoil 402 resembles the shape of a marine mammal's tail, with the hypotenuse side 408 of the right-angled triangular shape being indented toward the right angle corner 410. The right angle corner 410 of the airfoil 402 is mounted to the support arm 404. Each triangular airfoil 402 may also have a predefined curvature along the length L, causing the free side of the triangle opposite the right angle corner 410 to curve inwards towards the central shaft 406 during use. As shown in FIG. 7, the wind turbine 400 may include a single support arm 404 mounted to the central shaft 406. A counterweight 412 is provided at a first end 414 to balance the airfoil 402 mounted to a second end 416.

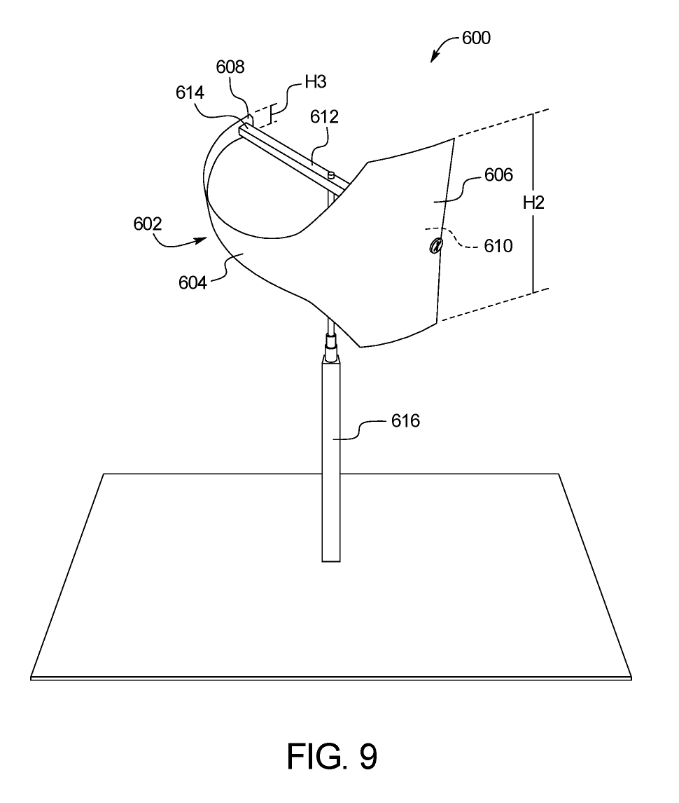

In a further embodiment of the wind turbine 500 illustrated in FIG. 8, the airfoils 502 have a rectangular shape with a predefined curve along its length L3. The illustrated airfoil 502 is attached to the support arm 503 along an edge 504, causing the opposing free edge 506 to curve inwards towards the central shaft 508.

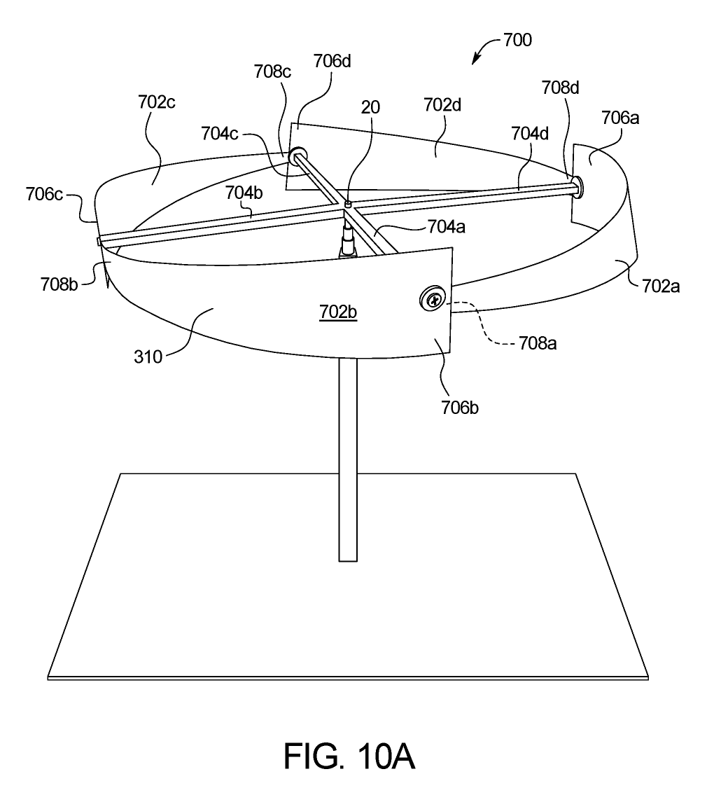

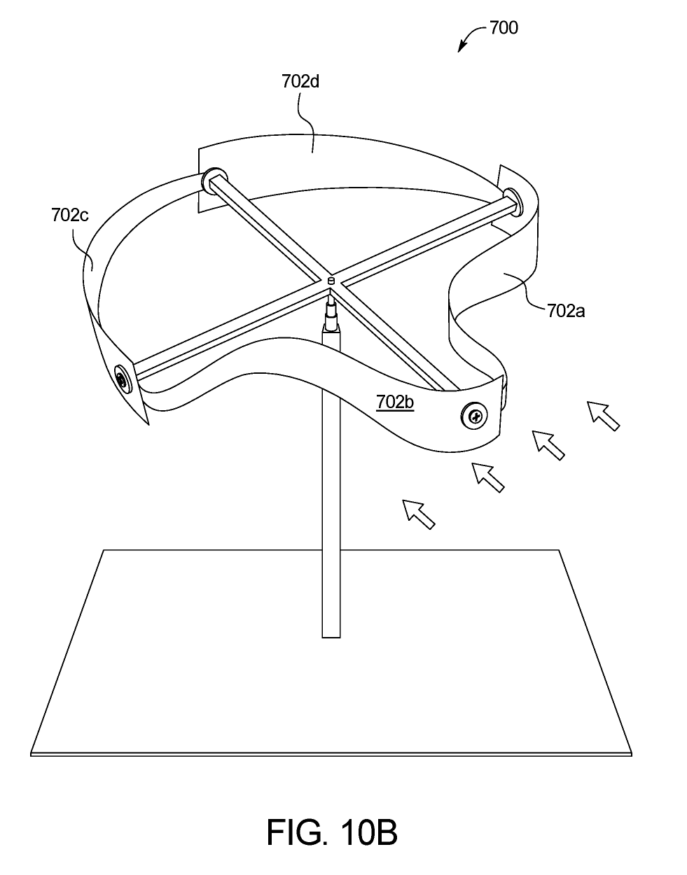

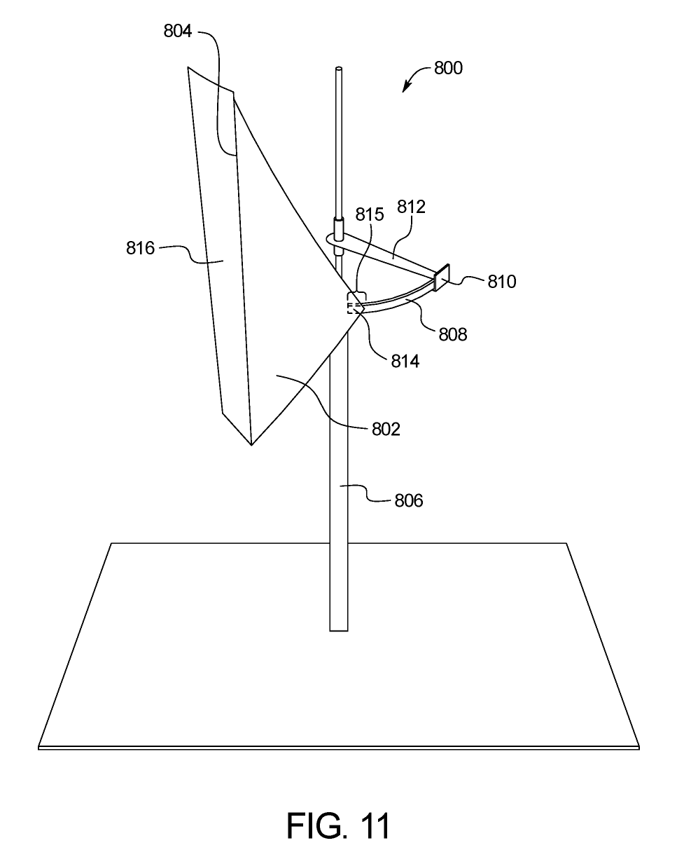

FIGS. 9, 10A, and 10B illustrate further embodiments of the wind turbines 600, 700 including airfoils that extend between adjacent support arms. The wind turbine 600 of FIG. 9 includes an airfoil 602 with a body 604 extending between a first end 606 and a second end 608. The first end 606 of the airfoil 602 is secured to a first end 610 of a support arm 612, and the second end 608 of the airfoil 602 is secured to a second end 614 of the support arm 612. The airfoil 602 may be connected to the ends 610, 614 through any fastening means such as a screw(s), a bolt(s), a mounting plate and bolts, or any other fastener(s). The airfoil 602 of FIG. 9 tapers from a greater height H2 at the first end 610 to a smaller height H3 at the second end 614. The body 604 of the airfoil 602 curves to form a semi-circle as it extends between the opposing ends 610, 614 of the support arm 612. During use, the body 604 flexes inwardly towards the central shaft 616 when facing the oncoming direction of air flow and flexes outwardly when facing away from the oncoming direction of air flow, moving between the inward and outward directions as the airfoil 602 rotates about the central shaft.

The wind turbine 700 of FIGS. 10A and 10B includes four tapered airfoils 702a-702d and four support arms 704a-704d, with each airfoil 702 forming a quarter of a circle as it extends between adjacent support arms 704. This attachment configuration results in a first end 708a of a first airfoil 702a and a second end 706b of a second airfoil 702b secured to an outer end of a single support arm 704a. As shown in FIG. 10B, the tapered airfoils 702 are made of flexible material that bends inwardly or outwardly depending on the direction from which the wind blows to aid in capturing wind energy.

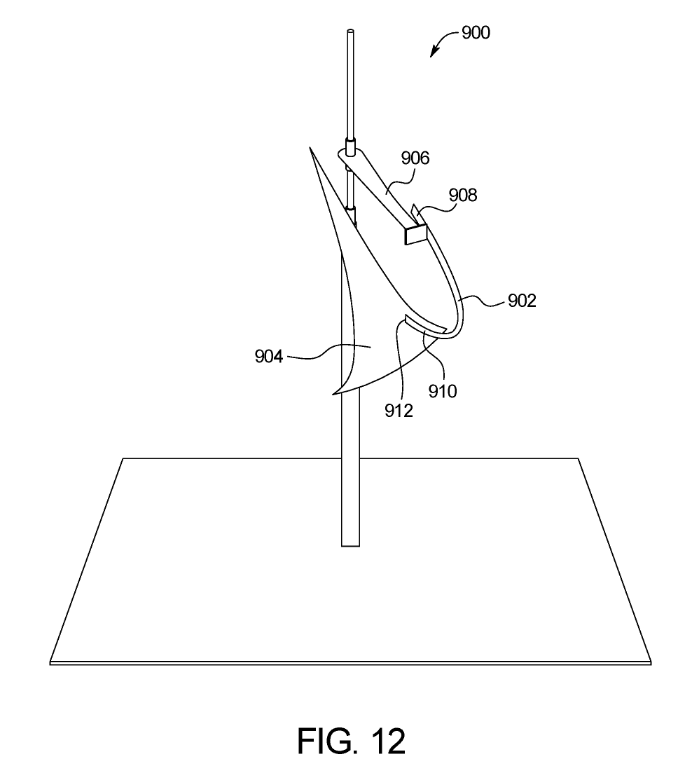

Each airfoil of the embodiments of FIGS. 11-15 are secured to an oscillating band that is mounted to an outer end of a support arm to promote movement of the airfoil in response to the wind. Referring to FIG. 11, the airfoil 802 of the wind turbine 800 is curved along its length so that the free end 804 of the airfoil 802 curves inwardly towards the central shaft 806. A first end 810 of the oscillating band 808 is mounted to the support arm 812 so that the oscillating band 808 extends perpendicularly to the length of the support arm 812. A second end 814 of the oscillating band 808 is secured to the airfoil 802 so that a portion 815 of the oscillating band 808 is coplanar with the body of the airfoil 802. The oscillating band 808 is made of a flexible material to allow the airfoil 802 to move in response to wind, allowing the airfoil 802 to move naturally to an optimal position to catch wind. Further, the airfoil 802 may also include a flap 816 on the free end to increase the surface area capturing the wind and to promote additional movement.

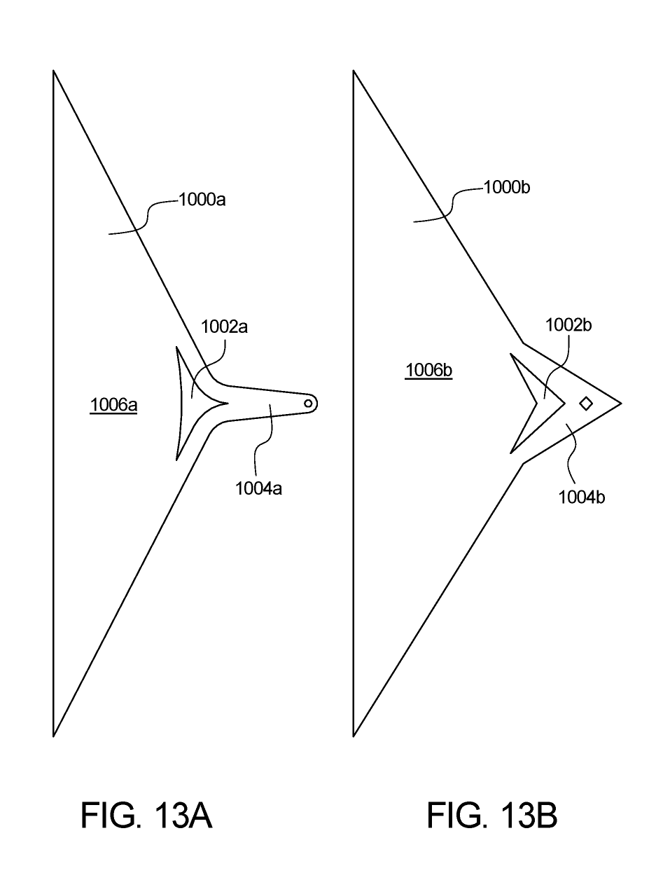

Referring to the wind turbine 900 of FIG. 12, the oscillating band 902 comprises a carbon fiber rod or other material of similar strength that provides additional support to the airfoil 904. In contrast to the oscillating band of FIG. 11, a first portion 904 of the oscillating band 902 of FIG. 12 extends parallel to the support arm 906 at the outer end 908. A second portion 910 of the oscillating band 902 is fastened to the airfoil 904 adjacent the second end 912 of the oscillating band 902 to provide additional rigidity to the airfoil 904.

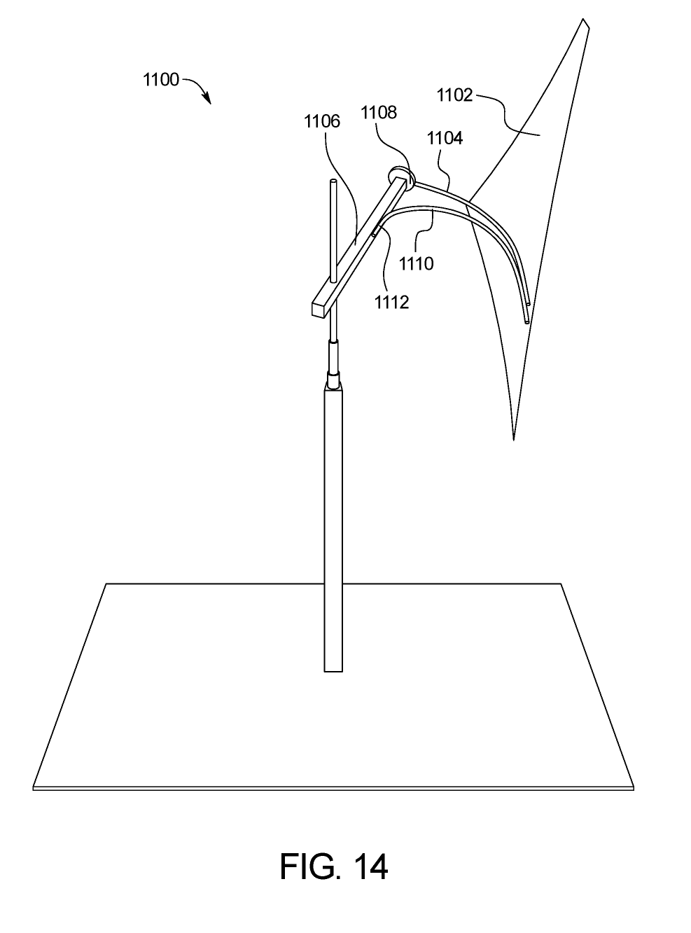

Referring to FIGS. 13A and 13B, the airfoil 1000a, 1000b may include an opening or cavity 1002a, 1002b to form the oscillating band 1004a, 1004b integrally with the body 1006a, 1006b of the airfoil 1000a, 1000b.

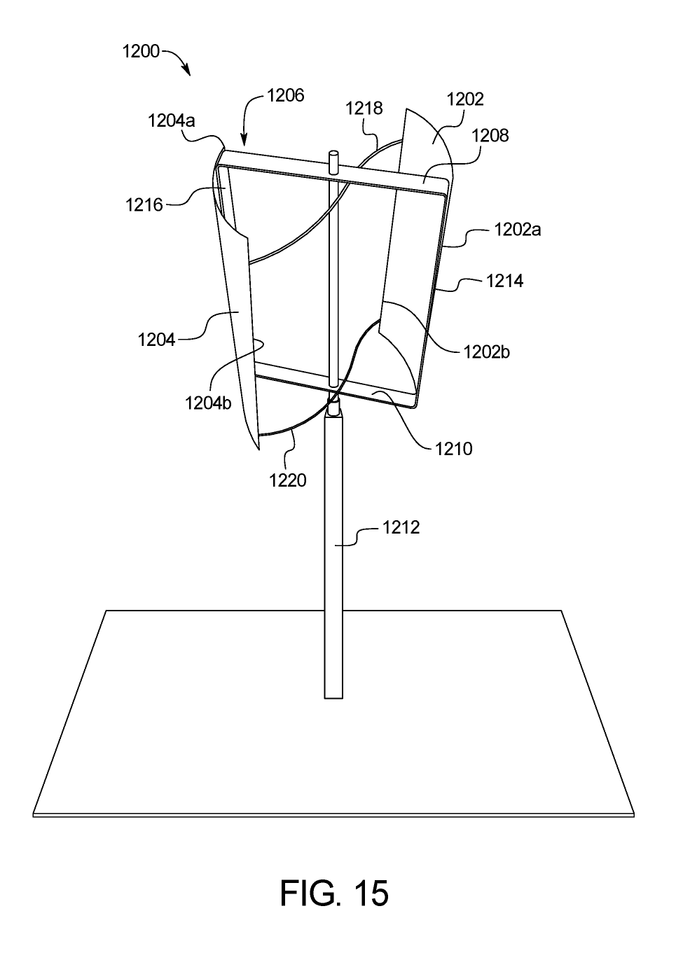

The wind turbine 1100 of FIG. 14 includes an airfoil 1102 secured to an oscillation band 1104 mounted on a support arm 1106 at a first connection point 1108. The airfoil 1102 is further supported by a control band 1110 that is attached to the support arm 1106 at a second connection point 1112 spaced from the first connection point 1108 of the oscillation band 1104. The control band 1110 provides additional stabilization and support to the airfoil 1002.

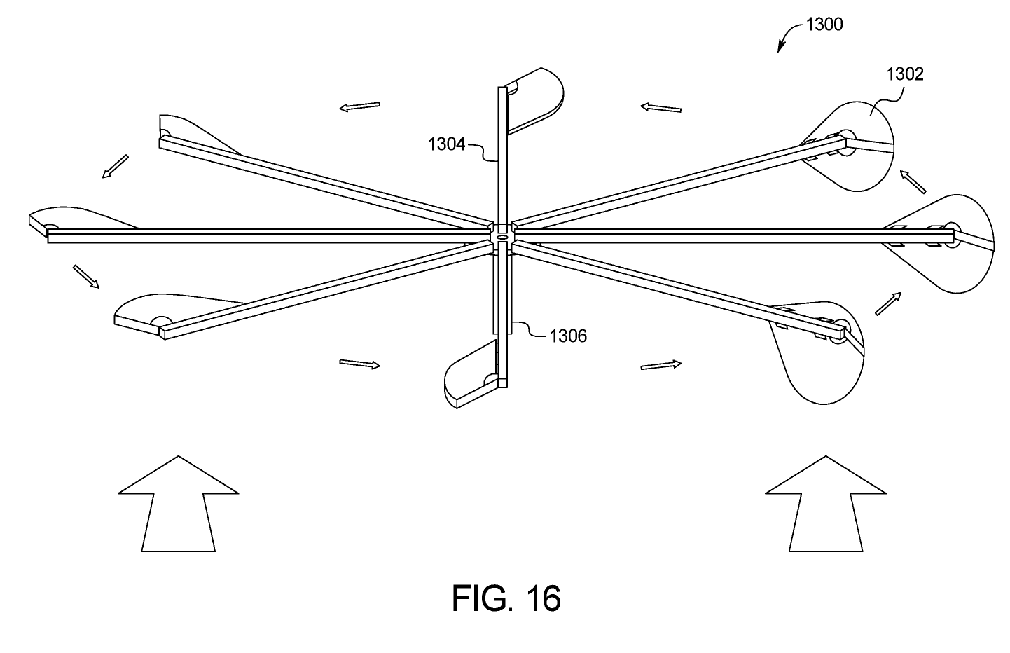

In FIG. 15, the wind turbine 1200 includes first and second airfoils 1202, 1204 secured to a support arm module 1206. The support arm module 1206 includes first and second parallel support arms 1208, 1210 spaced apart vertically on a central shaft 1212. First and second support bands 1214, 1216 extend between adjacent ends of the first and second parallel support arms 1208, 1210 parallel to the central shaft 1212. The first and second airfoils 1202, 1204 are secured to the first and second support bands 1214, 1216, respectively, along the height of the respective airfoil 1202, 1204 at a first side 1202a, 1204a. The airfoils 1202, 1204 are also connected by connecting bands 1218, 1220 extending between the second, free sides 1202b, 1204b of the airfoils 1202, 1204 at an upper position and a lower position, respectively. The connecting bands 1218, 1220 allow the force of the wind energy of one airfoil be used to move the other airfoil.

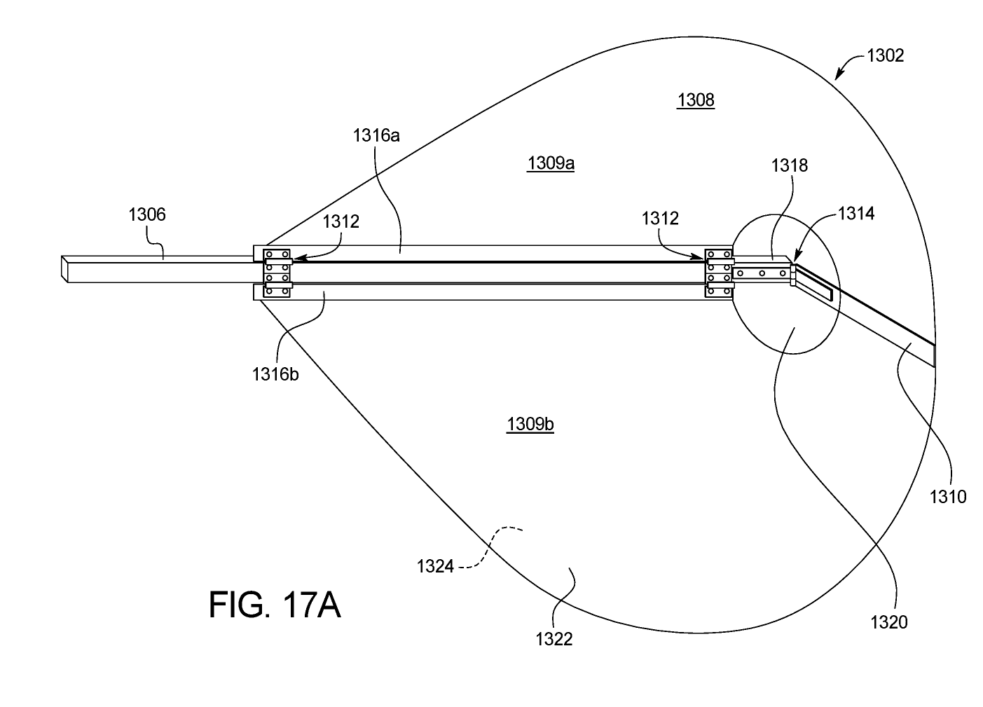

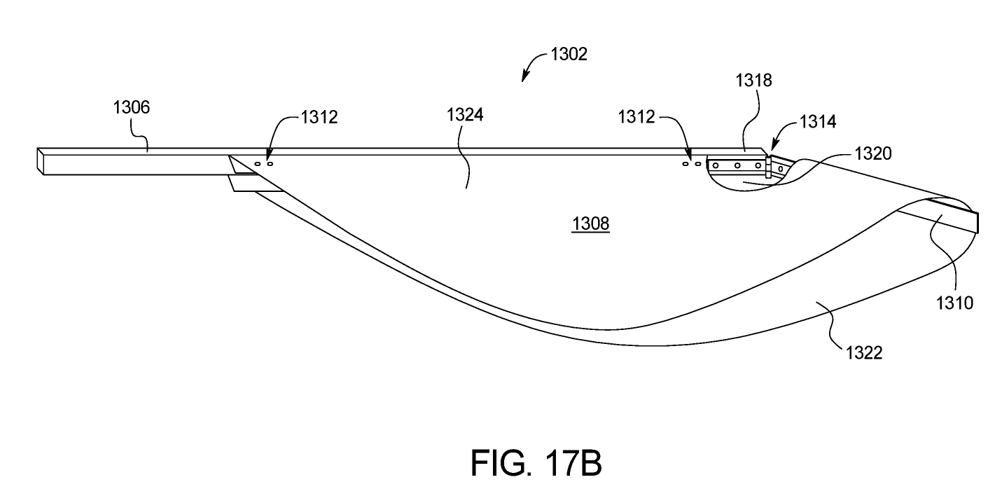

Referring to FIG. 16, the wind turbine 1300 includes a plurality of airfoils 1302 mounted to a plurality of support arms 1304 on to a central shaft 1306. Each airfoil 1302 moves between an open, expanded position and a closed, collapsed position shown in FIGS. 17A and 17B, respectively.

As shown in FIG. 17A, each airfoil 1302 includes an airfoil body 1308 and a rigid support 1310 that is mounted to the support arm 1304 through a number of hinges 1312, 1314. Specifically, each airfoil body 1308 is comprised of a material that is capable of flexing in response to wind pressure. The airfoil body 1308 has an arcuate shape extending between a first end 1316a and a second end 1316b. In the illustrated embodiment, the airfoil body 1308 has a C-shape, although other shapes and sizes may be used as desired or preferred. The airfoil body also includes a first portion 1309a adjacent to the first end 1316a and a second portion 1309b adjacent to the second end 1316b. The first and second ends 1316a, 1316b are secured to the respective support arm 1304 so the airfoil body 1308 forms a cone shape. The ends 1316a, 1316b of the airfoil body 1308 are secured to the support arm 1304 opposite one another by one or more end hinges 1312 or other suitable means to allow the airfoil 1302 to move between the open and closed positions.

The airfoil support 1310 is secured to a midpoint of the airfoil body 1308 and to the end 1318 of the support arm 1304 by a midpoint hinge 1314 or other suitable fastening means. In the illustrated embodiment, the airfoil support 1310 has a planar, rectangular shape, although linear, three-dimensional, or other shapes are envisioned. The rigid airfoil support 1310 extends at an obtuse angle from the support arm 1304 to facilitate movement between the expanded, open and collapsed, closed positions. As seen in FIG. 17A, the end hinges 1312 are spaced from the end 1318 of the support arm 1304 to allow room for the midpoint hinge 1314 to attach to the end 1318 of the support arm 1304. In some embodiments, the airfoil support 1310 rotates about the support arm 1304 as the airfoil body 1308 moves between the expanded and collapsed positions. Specifically, the midpoint hinge 1314 supports a range of movement of about 90 degrees, or about 45 degrees in either direction from a resting position. An opening 1320 is formed in the airfoil body 1308 around the midpoint hinge 1314 and the end 1318 of the support arm 1304.

When the front side 1322 of the airfoil 1302 faces the wind, the wind causes the airfoil 1302 to open or remain in the open position of FIG. 17A. As the support arms 1304 of the wind turbine 1300 rotate about the shaft 1306, the back side 1324 of the airfoil 1302 faces the wind, causing the airfoil 1302 to move into the closed position of FIG. 17B. More specifically, the first and second portions 1309a, 1309b of the airfoil body 1308 extend away from each other in the extended position and collapse together in the collapsed position, as shown in FIGS. 17A and 17B, respectively.

It should be noted that various changes and modifications to the presently preferred embodiments described herein will be apparent to those skilled in the art. Such changes and modifications may be made without departing from the spirit and scope of the present invention and without diminishing its attendant advantages.

1. An airfoil for a wind turbine apparatus including at least one support arm connected to a central shaft, wherein the at least one support arm includes an outer end distal to the central shaft, the airfoil comprising:
an airfoil body having an arcuate shape extending between a first end and a second end, the airfoil body including a first portion adjacent to the first end and a second portion adjacent to the second end, wherein the first end and the second end are secured to the support arm, wherein the body of the airfoil is comprised of material capable of flexing in response to wind pressure; and
an airfoil support secured to a midpoint on the airfoil body, and is connected to the outer end of the support arm;
wherein the airfoil moves between an expanded position and a collapsed position;
wherein the first and second portions of the airfoil body extend away from each other in the extended position and collapse together in the collapsed position; and
wherein the orientation of the airfoil relative to the direction of the wind causes the airfoil to move between the open and closed positions.

2. The airfoil of claim 1, wherein the airfoil body has a C-shape.

3. The airfoil of claim 2, wherein the airfoil body forms an opening around the end of the support arm.

4. The wind turbine of claim 1, wherein the airfoil body forms a cone shape in the expanded position.

5. The airfoil of claim 1, wherein the airfoil support comprises a planar structure secured to the airfoil body.

6. The airfoil of claim 5, wherein the airfoil support is secured to a midpoint on the airfoil body between the first portion and the second portion.

7. The airfoil of claim 1, wherein the airfoil support forms an obtuse angle with the support arm in a resting position.

8. The airfoil of claim 7, wherein the airfoil support pivots about the outer end of the support arm.

9. A wind turbine apparatus comprising:
a central shaft mounted on a base;
at least one support arm connected to the central shaft, wherein the at least one support arm includes an outer end distal to the central shaft; and
an airfoil comprising:
an airfoil body having an arcuate shape extending between a first end and a second end, the airfoil body including a first portion adjacent to the first end and a second portion adjacent to the second end, wherein the first end and the second end are secured to the support arm, wherein the body of the airfoil is comprised of material capable of flexing in response to wind pressure; and
an airfoil support secured to a midpoint on the airfoil body, and is connected to the outer end of the support arm;
wherein the airfoil moves between an expanded position and a collapsed position;
wherein the first and second portions of the airfoil body extend away from each other in the extended position and collapse together in the collapsed position; and
wherein the orientation of the airfoil relative to the direction of the wind causes the airfoil to move between the open and closed positions.

10. The wind turbine of claim 9 further comprising a plurality of support arms and a plurality of airfoils secured to the plurality of support arms.

11. A wind turbine apparatus comprising:
a shaft mounted on a base;
a disc support structure including an aperture that receives the shaft;
a plurality of support arms extending perpendicularly from the shaft; and
a plurality of airfoils, each airfoil secured to one of the plurality of support arms.

12. The wind turbine of claim 11, wherein the plurality of support arms at least partially supports the disc support structure.

13. The wind turbine of claim 11, wherein each airfoil has a width parallel to the central shaft and a length transverse to the width, and wherein each airfoil is curved along the length.

14. The wind turbine of claim 11, wherein each airfoil is one of rectangular, square, and triangular in shape.
